(19) United States
(12) Patent Application Publication
(10) Pub. No.: US 2019/0022669 A1
(43) Pub. Date: Jan. 24, 2019

(54) AIR PURIFICATION MODILE

(71) Applicant: An Johansson TIMOTHY, FOSHAN (CN)

(72) Inventor: An Johansson TIMOTHY, FOSHAN (CN)

(21) Appl. No.: 16/138,999

(22) Filed: Sep. 22, 2018

Related U.S. Application Data
(63) Continuation of application No. PCT/CN2017/072248, filed on Jan. 23, 2017.

(30) Foreign Application Priority Data
Apr. 15, 2016 (CN) 201610236657.7

(51) Int. Cl. B03C 3/155; B03C 3/41; B03C 3/47; B03C 3/70

(52) U.S. Cl. CPC B03C 3/155; B03C 3/70; B03C 3/47; B03C 3/41

(57) ABSTRACT

An air purification module comprises a positive filter plate, a negative filter plate, a filter member, and an insulating member. A number of the negative plate is two or more, each comprising a negative sieve and a negative frame. The negative frames of two adjacent negative filter plates are connected to form a receiving cavity. A number of the positive filter is one or more, each comprising a positive sieve and a positive frame. The positive filter plate carries positive electric charges and is arrange in the receiving cavity. The filter member is made of an insulating material and is arranged on two sides of the positive filter plate to prevent the positive filter plate from contacting the negative sieve on the two sides; the insulating member is provided on a periphery of the positive frame for preventing the positive filter plate from contacting the negative frame.

### CROSS-REFERENCE TO RELATED APPLICATIONS

This application is a continuation of International Patent Application No. PCT/CN2017/072248 with a filing date of Jan. 23, 2017, designating the U.S. and further claims priority to Chinese Patent Application No. 201610236657.7 with a filing date of Apr. 15, 2016. The content of the aforementioned applications, including any intervening amendments thereto, are incorporated herein by reference.

### TECHNICAL FIELD

The invention relates to the technical field of air filtration devices, and in particular to an air purification module.

### BACKGROUND OF THE PRESENT INVENTION

At present, there are mainly two kinds of filter sieve devices applied. One is the integrated filter sieve, in which multiple layers of filter sieves overlie each other in the same house, and the overlying multiple layers of the filter sieve cannot be separated from the box. The disadvantage of this kind of device is that the dirt is difficult to remove after entering, especially some fiber-like dirt such as catkins and bird feathers, since each layer of filter sieves can not be separated. The other one is multi-layer filter sieve, which comprises a plurality of different single-layer filter sieves assembled sequentially in a filter slot. In this filter sieve, the single-layer filter sieves are different and must be assembled in designed order, and the structure is complicate. It is convenient to clean for its detachable filter sieves. However, after the single-layer filter sieves are disassembled for cleaning together, it is difficult to reassemble them right sequence, which makes it hard to be managed. In addition, the filter devices in prior art are too thick and inconvenient to use.

### SUMMARY OF PRESENT INVENTION

The object of the disclosure is to provide an air purification module more suitable for use with compact structure, small volume, and strong adsorption capacity.

To achieve the object, the disclosure adopts following technical solutions:

An air purification module comprises: a positive filter plate, a negative filter plate, a filter member and an insulating member; a number of the negative plate is two or more, each comprising a negative sieve and a negative frame, and the negative frames of two adjacent negative filter plates are connected to form a receiving cavity; a number of the positive filter is one or more, each comprising a positive sieve and a positive frame, and the positive filter plate carries positive electric charges and is arrange in the receiving cavity; the filter member is made of an insulating material and is arranged on two sides of the positive filter plate to prevent the positive filter plate from contacting the negative sieve on the two sides; and the insulating member is provided on a periphery of the positive frame for preventing the positive filter plate from contacting the negative frame.

Further, two negative filter plates and one positive filter plate are provided to form a set of filtering unit.

Further, two adjacent negative filter plates are connected by a hinge and a locking device, and the hinge is arranged on one side of the negative filter plate, while the locking device is arranged on another side opposite to the hinge.

Further, the insulating member covers the periphery of the positive frame continuously.

Further, the insulating member covers the periphery of the positive frame intermittently.

Further, the positive filter plate is rectangular, and the insulating member is arranged at four vertex angles of the positive frame.

Further, a wire perforation is defined on the negative frame, and an annular wire is flexibly connected to the positive filter plate from the outside of the receiving cavity through the wire perforation for transporting positive charges to the positive filter plate.

Further, the negative plate is electrically neutral.

Further, the filter member is one or more of polyester wadding, filter paper, activated carbon filter cotton, non-woven fabric and HEPA filter paper.

Further, two sides of the filter member are closely adhered to the positive sieve and the negative sieve respectively, inner and outer sides of the insulating member are closely adhered to the positive frame and the negative frame respectively, and the filter member and the insulating member fix the positive filter plate.

According to the disclosure above, when two negative filter plates are closed together, the receiving cavity is formed therebetween for receiving the filter member and the positive filter plate, so as to make the structure compact, reduce the volume that the entire air purification module occupied, and reduce the cost. In addition to the filtering function, the filter member with insulating material can also be used to isolate the positive filter plate and the negative filter plate, and to avoid occurring a short circuit when the positive filter plate and the negative filter plate are contacted directly. The effect of high-voltage electrostatic dust removal is achieved. At the same time, bacteria in the strong electric field will be killed, making the air more fresh and sterile.

### DESCRIPTION OF THE DRAWINGS

FIG. 1 is a structural diagram of an air purification module without a filter member according to an embodiment of the disclosure;

FIG. 2 is a structural diagram of the air purification module with the filter member according to an embodiment of the disclosure;

FIG. 3 is a top view of the air purification module according to an embodiment of the disclosure;

FIG. 4 is a partial enlarged view of portion A shown in FIG. 2; and

FIG. 5 is a sectional view of the air purification module in a closed state with adjacent negative filter plates contacted with each other according to an embodiment of the disclosure.

In these figures: 1: positive filter plate, 11: positive sieve, 12: positive frame, 2: negative filter plate, 21: negative sieve, 22: negative frame, 23: wire perforation, 3: filter member, 4: insulating member, 5: receiving cavity, 61: hinge.

### DETAILED DESCRIPTION OF PREFERRED EMBODIMENTS

The technique solution in present disclosure will now be further described with reference to specific embodiments and the accompanying drawings.

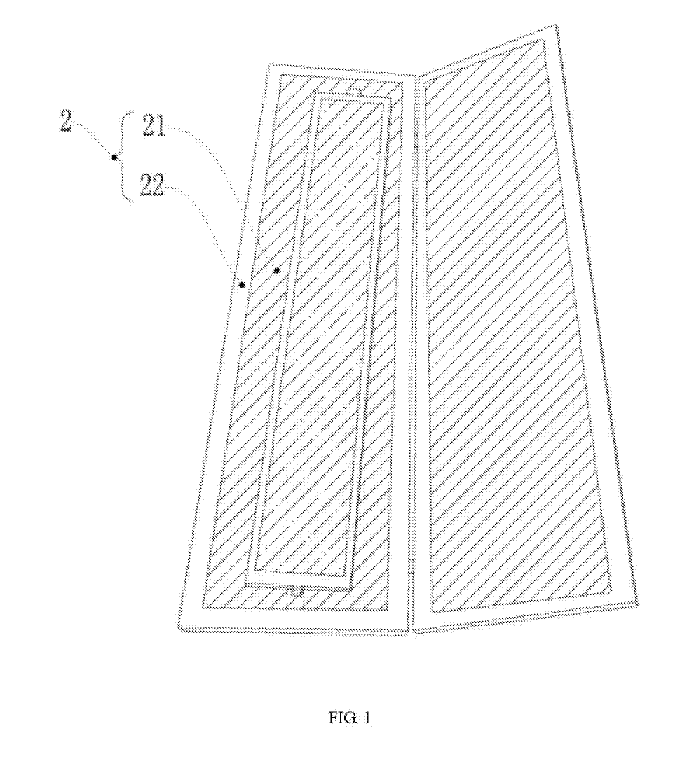

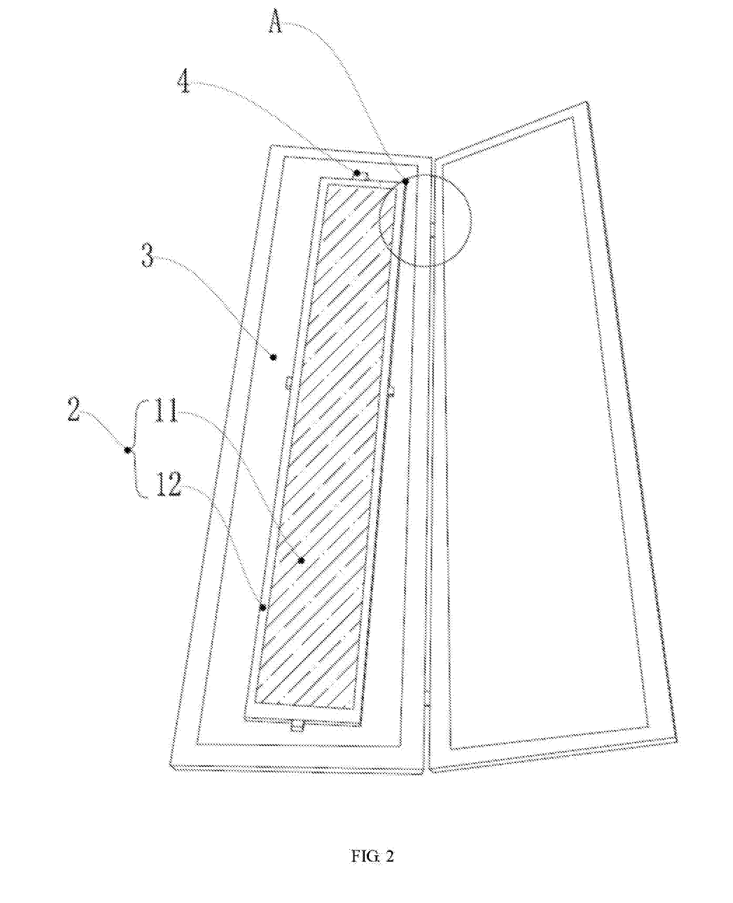

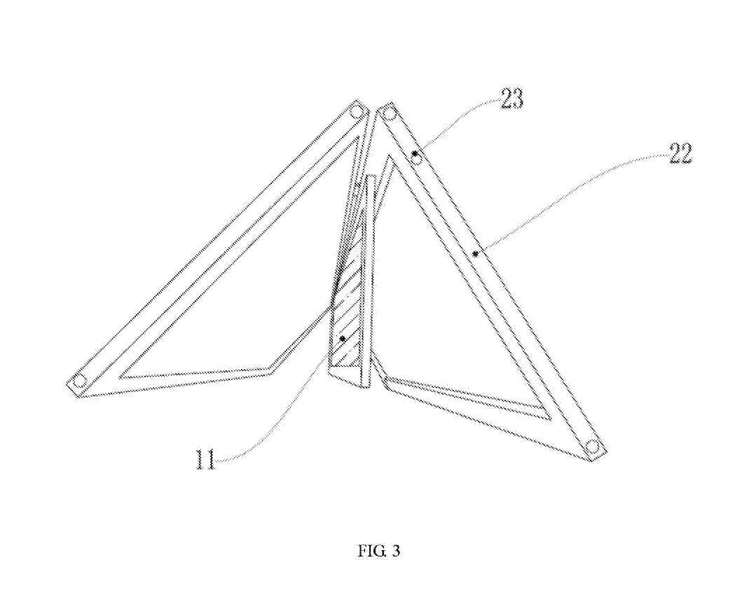

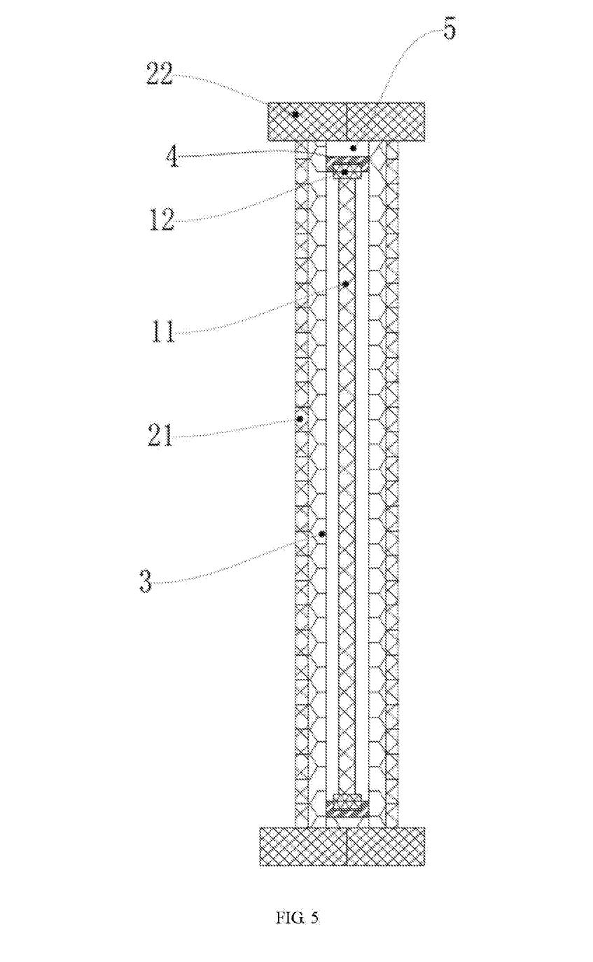

As shown in FIG. 1 to FIG. 5, an air purification module comprises: a positive filter plate 1, a negative filter plate 2, a filter member 3, and an insulating member 4.

The number of the negative plate 2 is two or more, each comprising a negative sieve 21 and a negative frame 22, and the negative frames 22 of two adjacent negative filter plates 2 are connected to form a receiving cavity 5.

The number of the positive filter plate 1 is one or more, each comprising a positive sieve 11 and a positive frame 12, and the positive filter plate 1 carries positive electric charges and is arrange in the receiving cavity 5.

The filter member 3 is made of an insulating material and is arranged on two sides of the positive filter plate 1 to prevent the positive filter plate 1 from contacting the negative sieve 21 on the two sides.

The insulating member 4 is provided on a periphery of the positive frame 12 for preventing the positive filter plate 1 from contacting the negative frame 22.

When two negative filter plates 2 are closed together, the receiving cavity 5 is formed therebetween for containing the filter member 3 and the positive filter plate 1, so as to make the stricture compact, reduce the volume that the entire air purification module occupied, and reduce the cost. In addition to the filtering function, the filter member 3 with insulating material can also be used to isolate the positive filter plate 1 and the negative filter plate 2, and to avoid occurring short circuit when the positive filter plate 1 and the negative filter plate 2 are contacted directly.

When the air purification module operates, the positive filter plate 1 in the receiving cavity 5 is connected to a voltage of several thousand volts and the positive filter plate 1 is positively charged, and thus a strong electric field is generated between the positive filter plate 1 and adjacent negative filter plate 2. Under the strong, electric field, air is ionized to produce free electrons, and these free electrons with small mass are easily absorbed by dust. Moreover, free electrons can move towards the positive filter plate 1 under the action of the strong electric field, so that more dusts are negatively charged. Most of these dusts will be tightly adsorbed by the filter member 3 for their large diameter during their movement to the positive filter plate 1, so as to filter dusts and achieve the effect of high-voltage electrostatic dust removal. At the same time, the bacteria in the strong electric field will be killed, making the air more fresh and sterile.

Further, two negative filter plates 2 and one positive filter plate 1 are provided to form a set of filtering unit. The number of the negative filter plate 2 and the positive filter plate 1 can be increased depend on needs, and the number of the negative filter plate 2 added should be equal to that of the positive filter plate added so as to adapt to different filtering requirements.

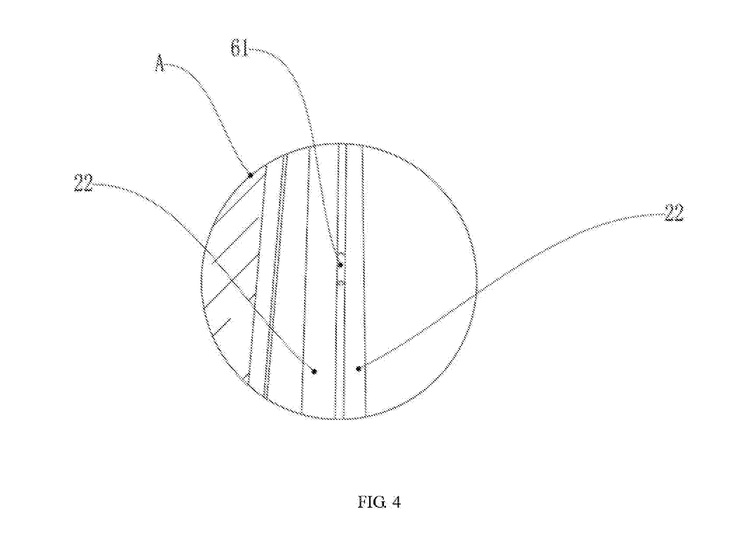

Further, referring to FIG. 4, the negative filter plates 2 are connected by a hinge 61 and a locking device, and the hinge 61 is arranged on one side of the negative filter plate 2, while the locking device is arranged on another side opposite to the hinge.

The filter member 3 is a consumption material, the design of the hinge 61 is convenient to open the two negative filter plates 2 and replace the filter member 3. For example, the locking device is a clamp. When closed, the two negative filter plates 2 will be clamped together by using the clamp, so as to improve the entail structural and working stability of the air purification module.

Further, the insulating member 4 covers the periphery of the positive frame 12 continuously, in order to ensure the stability of insulation between the positive filter plate 1 and the negative filter plate 2.

Further, the insulating member 4 covers the periphery of the positive frame 12 intermittently, so as to save the cost with the insulation requirement between the positive filter plate 1 and the negative filter plate 2 satisfied.

Further, the positive filter plate 1 is rectangular, and the insulating member 4 is arranged at four vertex angles of the positive frame 12. The rectangular frame is easy to process and costs little. The insulating member 4 is arranged at four vertex angles of the positive frame 1 to reduce the cost with the insulation requirement between the positive filter plate 1 and the negative filter plate 2 satisfied.

Further, a wire perforation 23 is defined on the negative frame 22, and an annular wire is flexibly connected to the positive filter plate 1 from the outside of the receiving cavity 5 through the wire perforation 23 for transporting positive charges to the positive filter plate 1.

The design of the wire perforation 23 makes the structure compact, and further reduces the volume that the entire air purification module occupied. The annular wire is in movable contact with the positive filter plate 1, so that the positive filter plate 1 can be positively charged and the air purification module is in a normal working state; on the other hand, the point discharging phenomenon can be prevented which can damage the air purification module. The wire perforation 23 is convenient for processing and costs little.

Further, the negative plate 2 is electrically neutral. The negative filter plate 2 is connected to a voltage of zero volts, so that the negative filter plate 2 is not charged, a strong electric field can be generated between the positive filter plate 1 and the negative filter plate 2 to ensure the efficiency of high-voltage electrostatic dust removal and avoid occurring the electric shock when the negative filter plate 2 is touched.

Further, the filter member is one or more of polyester wadding, filter paper, activated carbon filter cotton, non-woven fabric and HEPA filter paper. The types of the filter members 3 can be selected according to actual needs.

Further, two sides of the filter member 3 are closely adhered to the positive sieve 11 and the negative sieve 21 respectively, inner and outer sides of the insulating member 4 are closely adhered to the positive frame 12 and the negative frame 22 respectively, and the filter member 3 and the insulating member 4 fix the positive filter plate 1.

The filter member 3 and the insulating member 4 are also functioned to fix the positive filter plate 1 at the same time, which can further reduce the volume of the entire device.

The technical principles of the invention are illustrated with reference to specific embodiments. The above description is only for explaining principles instead of being construed as limiting the scope of the invention. Based on the explanation herein, it is easy for one of ordinary skill in the art to associate other embodiments according to the embodiments illustrated herein without any creative effort, and these embodiments should fall in the protecting scope of the invention.

I claim:

1. An air purification module, comprising:
a positive filter plate, a negative filter plate, a filter member and an insulating member; wherein
a number of the negative plate is two or more, each comprising a negative sieve and a negative frame, and negative frames of two adjacent negative filter plates are connected to form a receiving cavity;
a number of the positive filter is one or more, each comprising a positive sieve and a positive frame, and the positive filter plate carries positive electric charges and is arrange in the receiving cavity;
the filter member is made of an insulating material and is arranged on two sides of the positive filter plate to prevent the positive filter plate from contacting the negative sieve on the two sides;
the insulating member is provided on a periphery of the positive frame for preventing the positive filter plate from contacting the negative frame.

2. The air purification module according to claim 1, wherein two negative plates and one positive filter plate are provided to form a set of filtering unit.

3. The air purification module according to claim 1, wherein two adjacent negative filter plates are connected by a hinge and a locking device, and the hinge is arranged on one side of the negative filter plate, while the locking device is disposed on another side opposite to the hinge.

4. The air purification module according to claim 1, wherein the insulating member covers the periphery of the positive frame continuously.

5. The air purification module according to claim 1, wherein the insulating member covers the periphery of the positive frame intermittently.

6. The air purification module according to claim 1, wherein the positive filter plate is rectangular, and the insulating member is arranged at four vertex angles of the positive frame

7. The air purification module according to claim 1, wherein a wire perforation is defined on the negative frame, and an annular wire is flexibly connected to the positive filter plate from the outside of the receiving cavity through the wire perforation for transporting positive charges to the positive filter plate.

8. The air purification module according to claim 1, wherein the negative plate is electrically neutral.

9. The air purification module according to claim 1, wherein the filter member is one or more of polyester wadding, filter paper, activated carbon filter cotton, non-woven fabric and HEPA filter paper.

10. The air purification module according to claim 1, wherein two sides of the filter member are closely adhered to the positive sieve and the negative sieve respectively, inner and outer sides of the insulating member are closely adhered to the positive frame and the negative frame respectively, and the filter member and the insulating member fix the positive filter plate.
